(19) United States
(12) Patent Application Publication
(10) Pub. No.: US 2026/0003212 A1
(43) Pub. Date: Jan. 1, 2026

(54) DYNAMIC LIGHT SPECTRUM ABSORPTION EYEWEAR

(71) Applicant: Rutgers, The State University of New Jersey, New Brunswick, NJ (US)

(72) Inventors: Glenn G. Amatucci, Peapack, NJ (US); Alexandra Amatucci, Peapack, NJ (US)

(21) Appl. No.: 19/320,965

(22) Filed: Sep. 5, 2025

Related U.S. Application Data
(63) Continuation of application No. PCT/US2024/019350, filed on Mar. 11, 2024.
(60) Provisional application No. 63/451,021, filed on Mar. 9, 2023.

(51) Int. Cl. G02C 7/10; G02C 5/00; G02C 5/22; G02C 11/00

(52) U.S. Cl. CPC G02C 7/104; G02C 5/008; G02C 5/22; G02C 11/10

(57) ABSTRACT

Eyewear includes a frame and a pair of lenses installed on the frame. Each of the lenses is configured to absorb at least one absorption wavelength range of light. At least a portion of at least one of the lenses is configured to change the at least one absorption wavelength range of light absorbed in response to at least one of a physiological function, a psychological function, an external environment of a user of the eyewear, and/or manual input by a user. The frame is a three-dimensional printed frame. The eyewear includes at least one battery encapsulated within the frame. The at least one battery is resistant to elevated temperatures during construction of the frame and encapsulation of the

### CROSS-REFERENCE TO RELATED APPLICATION

This application is a Continuation Application relating to and claiming the benefit of commonly-owned, co-pending PCT International Application No. PCT/US2024/019350, titled “DYNAMIC LIGHT SPECTRUM ABSORPTION EYEWEAR,” filed Mar. 11, 2024, which claims priority to and the benefit of U.S. Provisional Patent Application Ser. No. 63/451,021, filed Mar. 9, 2023, entitled “DYNAMIC LIGHT SPECTRUM ABSORPTION EYEWEAR,” the contents of each of which are incorporated herein by reference in its entirety.

### FIELD OF THE INVENTION

The present invention relates to eyewear and, more particularly, eyeglasses having lenses that are configured to change color in response to at least one of a physiological function and an external environment of a user of the eyewear.

### BACKGROUND

The possibility for color to affect one's mood or psychological state, and the fact that color-emotion associations are real has been shown. While the researched color-emotion associations are an important benchmark, said associations are not necessarily true for everyone. Color-emotion associations can be subjective, depending on particular experiences or cultural differences.

The influence of color on emotion is known such that both neutral and surprised facial expressions (the surprised expression was used as it can be seen as both negative or positive) of men and women had colored background: red vs. green as opposed to an achromatic background (grey) and as well as a background with mixed colors, the hypothetically opposed colors red and green. The participants were told that the experiment concerned the categorization of ambiguous emotional expressions. They were then instructed to indicate whether the faces expressed broadly negative or broadly positive emotions. The results revealed that both for male and female faces, the color red was more likely to prompt negative responses. Generally, it was only color that significantly predicted negative responses, neither the facial expressions, nor the gender. Their extensive study showed that red is negatively charged, but also indicated the positive meaning of green. The key finding is that red prompted participants to perceive the same set of faces more negatively than green did, with the two control colors producing intermediate results.

The effect colors can have on one's psychological state has also been shown in a long-term study in Japan. At the platforms of a total of 71 train stations, light-emitting diodes (LED) were installed. At 60 of these stations, white LED were installed (control group) and in the other 11 stations (treatment group), blue LED (with the color blue known to have a calming effect on emotions) were installed. The results for the treatment group showed a staggering decrease of suicide attempts of 84%.

Not only can color be used to influence mood or a psychological state, but colors could also be a useful factor in pain management. In a study, rats were exposed to green light-emitting diode (GLED) strips for a certain amount of time over several days. Also, green lenses were inserted in the rat's eyes. As a result, their antinociceptive level went up, meaning their perception of pain changed, resulting in higher pain tolerance. These findings indicate that color could also be used in pain management.

Further research was conducted to test these findings on patients suffering from Fibromyalgia, which is a chronic disorder that causes pain and tenderness throughout the body. Several patients in this experiment were exposed to GLED for 8 hours a day for 5 days. Like the findings with rats in their earlier study, pain was perceived as significantly reduced by these patients, which shows the power of colors on the human body, even for pain management. To solidify these findings, Ibrahim also went on to test this theory on migraine patients and was able to find similar effects: Both episodic migraine patients as well as chronic migraine patients were emitted to both white LED and GLED. While the exposure to white LED showed very little pain reduction, exposure to GLED showed a significant drop in pain perception in both patient groups (episodic and chronic).

Colors can not only influence emotions and psychological wellbeing, but also psychological as well as physiological performance in different ways. For example, tinted color lenses in visual aids are used in patients with visual impairments such as CVD (color vision deficiency). These tinted lenses can filter out certain problematic wavelengths and therefore reintroduce the ability to distinguish between colors, i.e., blue-yellow, and red-green, making everyday life for patients with CVD much easier and safer (i.e., when driving or walking with regards to traffic lights).

In the area of alpine ski sports research has been undergone to determine whether filtered lenses can help enhance performance in vision with regards to better reaction as well as contrast enhancement when on the ski slope. With varying light conditions on the slope due to fog, overcast skies or snowfall, vision enhancement and therefore performance enhancement can be a determining factor in success at the sport as well as reduction of accidents and injury. Color of snow is blue and not white. The reason we see snow as white is due to a shift in our visual system. However, snow is illuminated by the blue sky, thus of course the most energy is concentrated in the blue range resulting in a specifically perceived wavelength. Due to this effect, colors are perceived as desaturated and visual aid in form of a blue attenuator filter is necessary to help saturate the visual color spectrum. The German Ski Federation World Cup has already been using such filters for the women's team and it was possible to prove physiological evidence of vision enhancement with such lenses.

Shifting to color-tinted lenses and the improvement of wellbeing through pain relief with the help of colors, it has been proven that children who suffer from visual stress and/or headaches have fewer symptoms when wearing colored lenses. Prescription of colored-lenses to children suffering from Meares-Irlen syndrome was conducted. Meares-Irlen syndrome is a form of visual stress that leads to difficulties, for example, in reading. These findings were further tested, namely, the use of colored lenses on children with headaches or other visual stress and were able to find that particularly for patients with severe headaches and migraines, such colored lenses were able to relieve pain.

Apart from performance enhancement for impairments, colors can also influence performance in cognitive tasks. It has been shown that the color red as opposed to blue induces primarily an avoidance as opposed to an approach motivation and that red enhances performance when performing a detail-oriented task, whereas blue enhances performance when performing a creative task. Evidence indicated the activation of alternative motivations mediates the effect of color on cognitive task performances.

From a design perspective, observations and studies of such effects have been recorded and guide the selection of color for interior spaces. The choice of color in interior spaces represents an integral part of interior design and can enhance wellbeing and quality of life. The complex nature of colors and their impact on art, culture, psychology, and religion has been an important area of research for interior design. Color is observed as a fundamental quality of our visual perception. There are numerous developed theories and assumptions related to the aesthetic comfort offered by colors, and to their effect on human psyche. A space with its choice of colors can exude comfort and serenity, while on the other hand, colors can cause a feeling of annoyance and discomfort. They are a very powerful tool in the area of interior design as they can create a plethora of illusions in different spaces. A room can, for example, seem larger or also smaller, depending on the choice of color. When architecture itself does not permit changes and flexibility, one of most the important solutions are colors.

Red, for example, is one of the most vibrant colors and can express passion, love, warmth, excitement, power etc. Also, this color also attracts immediate attention. Blue on the other hand is a color of harmony and peace, but can also be recognized as cold, unemotional, and unfriendly. Yellow has a different effect: it is associated with joy and optimism and can also help with concentration and focus. Green is the color of nature, its restful and can be refreshing and can also be seen as calming. Purple is a more mystical color and can seem mysterious. It can also be associated with sensitivity and artistic nature. These are just a few of many colors and many color-emotion associations shown as an example and they are tremendously important in interior design.

In the realms of fashion color also plays an important role. Large amounts of money are paid to determine which seasonal color palettes fit to ones' skin tone, hair and even shape. Research has shown that there are different seasonal types, color schemes, and suggested designs that fit each type. It is possible to find out the relation between seasonal color type and an outfit to use the colors effectively, which can be reflected in one's outlook and mood.

In conclusion, color can influence mood and the psychological state of mind. It is also clear, that color can help with pain management, performance enhancement, color blindness and generally improve wellbeing, when used correctly. Even in interior design and interior spaces colors are widely known to be an important factor and can “make or break” a room. As proven, there has been an effort to quantitatively assess the impact of color on an individual's psychological state to induce a wide range of responses such as relaxation. This approach has utility as it can avoid the use of medication to alter a patient's psychological state.

Also, there is a need for new therapeutic treatments in place of, or in conjunction with, pharmaceuticals to treat mood disorders ranging from depression, anxiety, lack of motivation, and hyperactivity. In addition, pharmaceuticals are taken legally or illegally to enhance both mental and physical performance. Pharmaceuticals, although effective, have various drawbacks ranging from debilitating side effects, high cost, environmental pollution in wastewater and unnecessary prescription for mild cases of disorder. There is a need for alternative treatments that can eliminate or reduce the dependence on such psychological medication.

### SUMMARY

In some embodiments, eyewear includes a frame; and a pair of lenses installed on the frame, wherein each of the lenses is configured to absorb at least one absorption wavelength range of light, and wherein at least a portion of at least one of the lenses is configured to change the at least one absorption wavelength range of light absorbed in response to at least one of a physiological function, a psychological function, an external environment of a user of the eyewear, and/or manual input by a user. In some embodiments, the at least one absorption wavelength range of light includes a plurality of absorption wavelength ranges of light. In some embodiments, the at least a portion of the at least one of the lenses is configured to change between one of the plurality of absorption wavelength ranges of light and another of the plurality of absorption wavelength ranges of light. In some embodiments, the at least one absorption wavelength range of light is on a visible spectrum, and wherein the at least a portion of the at least one of the lenses is configured to change color.

In some embodiments, each of the lenses includes an electrochromic lens. In some embodiments, each of the lenses is coated with an electrochromic film device. In some embodiments, the electrochromic film device is composed of an inorganic material. In some embodiments, the inorganic material is a transition metal oxide or a plasmonic material. In some embodiments, the transition metal oxide includes vanadium oxide or tungsten oxide. In some embodiments, the electrochromic film device is comprised of an organic material. In some embodiments, the organic material is an organic redox material such as Poly (3hexyl)-thiophene (P3HT), polyani-line (PANI), or polypyrrole (PPy). In some embodiments, the plasmonic material includes plasmonic nanostructures.

In some embodiments, the electrochromic film device includes a plurality of conducting electrodes, wherein the plurality of conducting electrodes provide pixel resolution. In some embodiments, the electrochromic film device includes a red-green-blue (RGB) lateral array. In some embodiments, the electrochromic film device includes a cyan-magenta-yellow (CMY) stacked array.

In some embodiments, the eyewear includes a power source and at least one electrical circuit, wherein the power source is configured to provide power to at least one electrical circuit, and wherein the at least one electrical circuit is configured to control a change of the at least one absorption wavelength range of light absorbed by each of the lenses. In some embodiments, the power source includes at least one battery. In some embodiments, the frame includes an outer surface, and wherein the at least one battery is attached to the outer surface. In some embodiments, the at least one battery is embedded within the frame. In some embodiments, the frame has a thickness of 0.3 mm to 7 mm. In some embodiments, the at least one electrical circuit is embedded within the frame. In some embodiments, the at least one battery is embedded within the frame by 3-D printing. In some embodiments, the frame includes a bridge, and wherein the at least one battery is embedded within the bridge. In some embodiments, the frame includes a pair of temples, and wherein the at least one battery is embedded in at least one of the temples. In some embodiments, the frame includes a pair of rims, and wherein the at least one battery is embedded in at least one of the rims. In some embodiments, the at least one battery is resistant to a temperature of 85° C. to 250° C. In some embodiments, the at least one battery includes at least two cells, and wherein each of the at least two cells is embedded in a corresponding one of the pair of temples. In some embodiments, the at least one battery comprises poly-para-xylylene.

In some embodiments, the eyewear includes at least one sensor, wherein the at least one sensor is configured to detect one or more of the physiological function, the psychological function, and the external environment. In some embodiments, the physiological function includes a pulse rate, blood pressure, perspiration, pupil dilation, temperature, brain activity, or a combination of two or more thereof. In some embodiments, the external environment includes ambient lighting, direction, presence of wavelengths less than 450 nm, presence of ultraviolet light, altitude, radio frequency radiation, acoustic signatures, or a combination of two or more thereof.

In some embodiments, the at least one absorption wavelength range of light absorbed by a first portion and a second portion of at least one of the lenses is configured to change, wherein the at least one absorption wavelength range of light absorbed by the first portion is a first absorption wavelength range of light, and wherein the at least one absorption wavelength range of light absorbed by a second portion is a second absorption wavelength range of light, and wherein the first absorption wavelength range of light is different from the second absorption wavelength range of light.

In some embodiments, the at least one absorption wavelength range of light absorbed by the first portion and the second portion of each of the lenses is configured to change, wherein the at least one absorption wavelength range of light absorbed by the first portion of a first one of the lenses is a first absorption wavelength range of light, and wherein the at least one absorption wavelength range of light absorbed by the second portion of the first one of the lenses is a second absorption wavelength range of light, and wherein the first absorption wavelength range of light is different from the second absorption wavelength range of light, wherein the at least one absorption wavelength range of light absorbed by the first portion of a second one of the lenses is a third absorption wavelength range of light, and wherein the at least one absorption wavelength range of light absorbed by the second portion of the second one of the lenses is a fourth absorption wavelength range of light, and wherein the third absorption wavelength range of light is different from the fourth absorption wavelength range of light.

In some embodiments, the at least a portion of at least one of the lenses is substantially transparent.

In some embodiments, the at least one absorption wavelength range of light absorbed by a first one of the pair of lenses is a first absorption wavelength range of light, and wherein the at least one absorption wavelength range of light absorbed by a second one of the pair of lenses is a second absorption wavelength range of light, and wherein the first absorption wavelength range of light is different from the second absorption wavelength range of light.

In some embodiments, a system includes the one or more of the embodiments of the eyewear and at least one sensor, wherein the at least one sensor is separate and located remote from the eyewear, and wherein the at least one sensor is configured to detect one or more of the physiological function, the psychological function, and the external environment.

In some embodiments, eyewear includes a frame; wherein the frame includes a pair of rims, and a pair of endpieces; a pair of temples, each of which is movably attached to a corresponding one of pair of the endpieces, wherein each of the temples is attached to the corresponding one of endpieces by a corresponding one of a pair of hinges, wherein each of the hinges is includes at least one electrical conducting pathway from the corresponding one of the temples to the corresponding one of the endpieces; and a pair of lenses installed on the frame, wherein each of the lenses is configured to absorb at least one absorption wavelength range of light, wherein at least a portion of at least one of the lenses is configured to change the at least one absorption wavelength range of light in response to at least one of a physiological function, psychological function, an external environment of a user of the eyewear, and/or manual input by a user, wherein each of the hinges are configured to transmit power and electronic information from the temples to the rims.

In some embodiments, each of the hinges is configured to independently transmit power and electronic information from a corresponding one of the temples to a corresponding one of the rims. In some embodiments, each of the hinges is a barrel hinge. In some embodiments, each of the hinges includes a first barrel and a second barrel, wherein the first barrel and the second barrel are in electronic contact with one another, wherein each of the hinges includes a third barrel and a fourth barrel, wherein the third barrel and the fourth barrel are in electronic contact with one another, and wherein the first barrel and the second barrel are electronically isolated from the third barrel and the fourth barrel.

In some embodiments, the frame includes a pair of endpieces, wherein each of the pair of temples is movably attached to a corresponding one of the endpieces, wherein the first barrel of each of the hinges is attached to a corresponding one of the pair of the endpieces, wherein the second barrel of each of the hinges is attached to a corresponding one of the pair of the temples, wherein the third barrel of each of the hinges is attached to the corresponding one of the pair of the temples, and wherein the fourth barrel of each of the hinges is attached to the corresponding one of the pair of the endpieces.

In some embodiments, the first barrel of each of the hinges is attached to the corresponding one of the pair of the endpieces by a first conductor pad, wherein the second barrel of each of the hinges is attached to the corresponding one of the pair of the temples by a second conductor pad, wherein the third barrel of each of the hinges is attached to the corresponding one of the pair of the temples temple by a third conductor pad, and wherein the fourth barrel of each of the hinges is attached to the corresponding one of the pair of the endpieces by a fourth conductor pad.

In some embodiments, each of the endpieces includes a first circuit member and a second circuit member, wherein each of the temples includes a third circuit member and a fourth circuit member, wherein each of the first circuit members is connected to a corresponding one of the first conductor pads, wherein each of the second circuit members is connected to a corresponding one of the second conductor pads, wherein each of the third circuit members is connected to a corresponding one of the third conductor pads, and wherein each of the fourth circuit members is connected to a corresponding one of the fourth conductor pads.

In some embodiments, each of the hinges includes at least one fastener to fasten the first barrel and the second barrel, the third barrel and the fourth barrel to one another. In some embodiments, the at least one fastener electronically isolates the first barrel and the second barrel from the third barrel and the fourth barrel. In some embodiments, each of the hinges includes a disc, wherein the disc is between the second barrel and the third barrel. In some embodiments, the disc electronically isolates the first barrel and the second barrel from the third barrel and the fourth barrel. In some embodiments, each of the hinges includes an electronically isolating coating.

In some embodiments, a helmet includes a shell; and a visor installed on the shell, wherein the visor is configured to absorb at least one absorption wavelength range of light, and wherein at least a portion of the visor is configured to change the at least one absorption wavelength range of light absorbed in response to at least one of a physiological function, a psychological function, an external environment of a user of the helmet, and/or manual input by the user. In some embodiments, the at least one absorption wavelength range of light is on a visible spectrum, and wherein the at least a portion of the visor is configured to change color. In some embodiments, the visor is electrochromic. In some embodiments, the helmet includes at least one battery and at least one electrical circuit, wherein the at least one battery is configured to provide power to the at least one electrical circuit, and wherein the at least one electrical circuit is configured to control a change of the at least one absorption wavelength ranges of light absorbed by the visor. In some embodiments, the shell includes a wall having a thickness of 1 mm to 40 mm, and wherein the at least one battery is encapsulated in the wall.

In some embodiments, eyewear includes a three-dimensional printed frame; and at least one battery encapsulated within the frame, wherein the at least one battery is resistant to a temperature of 85° C. to 250° C. In some embodiments, the frame has a thickness of 0.3 mm to 7 mm. In some embodiments, the frame is a temple, a rim, or a bridge of the eyewear.

In some embodiments, the eyewear includes physiological or environmental sensors that actively adjust wavelength absorbance of a lens located in an eyeglass frame and facilitates the reduction of stress on the user (e.g., psychological stress or physiological stress). In some embodiments, the eyewear includes one or more of the following features:
1. An eyewear lens comprised of an electrochromic material to change the transmission and absorption of wavelengths of the lens.
2. An eyewear frame which contains a power source, such as a battery.
3. An eyewear frame which contains a control circuit.
4. A physiological and/or environmental sensor(s) that are co-located on the frame and/or are located remotely therefrom, which actively control the absorption of the lens through communication with the control circuit.

In some embodiments, the colors of the lenses can change to help improve mood, enhance performance, can help calm one's mind, support with reintroducing colors in vision for people with color blindness, and colors of the lenses can be changed for fashionable reasons, and colors can even relieve pain. In some embodiments, anxiety could be measured by the sensors installed in the rims of the eyewear behind the ears. This area is closest to bare skin and could early on determine blood pressure or perspiration of the skin. As a result, the lenses could be programmed to change to ones preferred color. Particularly in the areas of psychology, aerospace, air travel and military, among others, the eyewear utilizes colors to calm or help concentration.

In some embodiments, the eyewear includes electrochromics to employ changes in wavelength absorption within the lenses by installation of a small camera on the inside of the rims close to the eye. In some embodiments, the camera measures the size of the pupil and thus automatically change the tint of the lenses, depending on need and light exposure to the eye to maintain an optimal pupil dilation for vision performance.

### BRIEF DESCRIPTION OF THE DRAWINGS

FIG. 1 is a perspective view of some embodiments of eyewear;

FIG. 2 is a perspective view of some embodiments of eyewear;

FIG. 3 is an exploded side elevational view of some embodiments of a hinge of eyewear;

FIG. 4 is a side elevational view of the hinge of FIG. 3 with corresponding conductive pads;

FIG. 5 is a side elevational view of the hinge and conductive pads of FIG. 4 attached to a temple and endpiece of an eyewear frame;

FIG. 6 is a photo of an embedded Li-ion battery within a representative temple frame material fabricated by elevated temperature FDM 3-D printing;

FIG. 7 is a graph showing voltage vs. time for the embedded Li-ion battery within representative temple frame material of FIG. 6 versus two benchmark Li-ion batteries of a same construction without embedding demonstrating similar performance;

FIG. 8 is a graph showing capacity versus cycle number for an embedded Li-ion battery within representative temple frame material of FIG. 6 versus two benchmark Li-ion batteries of same construction without embedding demonstrating similar performance;

FIGS. 9 and 9A are schematic views of a lens employed by eyewear;

FIG. 10 is a schematic view of an electrochromic stack;

FIG. 11 is a schematic view of a lateral pixel electrochromic array using red-blue-green (RGB) approach for wide color spectra;

FIG. 12 is a schematic view of stacked pixel electrochromic array using cyan-magenta-yellow (CMY) approach for wide color; and

FIG. 13 is a perspective view of some embodiments of a helmet.

### DETAILED DESCRIPTION

In some embodiments, as used herein, the term “light” is defined as electromagnetic radiation of any wavelength and includes, but is not limited to, visible wavelengths, such as visible light, and nonvisible wavelengths, such as ultraviolet radiation, infrared radiation, X-rays, radio waves, and gamma rays.

In some embodiments, as used herein, the term “color” is defined as the aspect or perception of an appearance of an object caused by differing qualities or light reflected or emitted by it or enabled to transmit through it expressed as hue, lightness (or brightness), and saturation.

In some embodiments, as used herein, the term “visible spectrum” is defined as visible light having a wavelength of 400 nm to 700 nm.

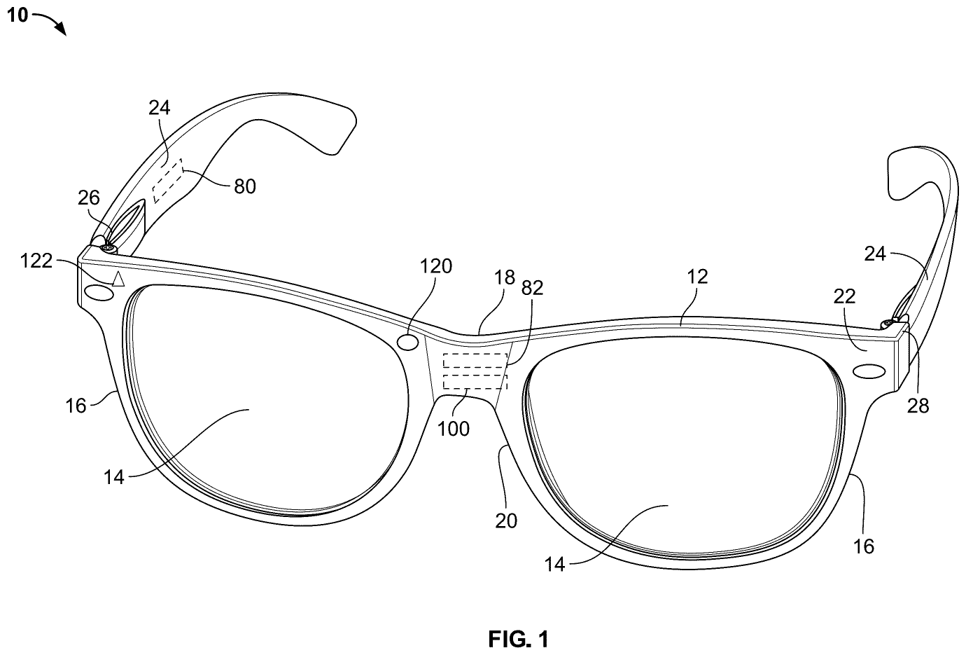

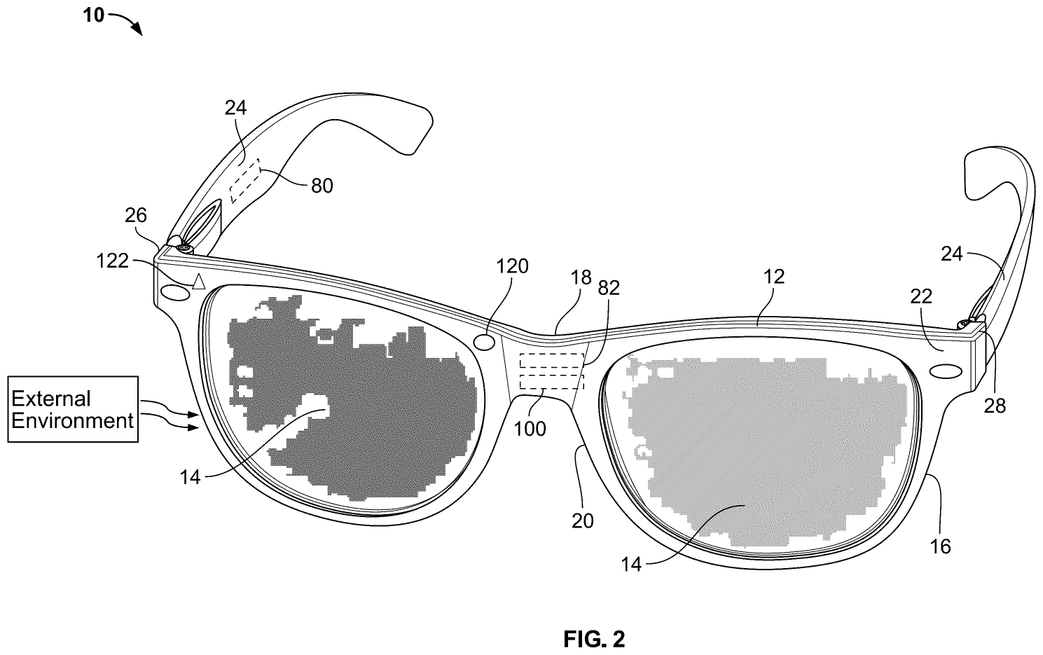

Referring to FIGS. 1 and 2, in some embodiments, eyewear 10 includes a frame 12 and a pair of lenses 14 installed in the frame 12. In some embodiments, the eyewear 10 is eyeglasses. In some embodiments, the eyewear 10 is reading glasses. In some embodiments, the eyewear 10 is prescription eyeglasses. In some embodiments, the eyewear 10 is bifocal eyewear. In some embodiments, the eyewear 10 is nonprescription eyeglasses. In some embodiments, the eyewear 10 is sunglasses. In some embodiments, the eyewear 10 is prescription sunglasses. In some embodiments, the eyewear 10 is nonprescription sunglasses. In some embodiments, the eyewear 10 is sports eyewear. In some embodiments, the eyewear 10 is fashion eyewear. In some embodiments, the eyewear 10 is an information display. In some embodiments, the frame 12 is a full frame. In some embodiments, the frame 12 is a rimless frame. In some embodiments, the frame 12 is a semi-rimless frame.

In some embodiments, the frame 12 has a thickness of 0.3 mm to 7 mm. In some embodiments, the thickness of the frame 12 is in its thinnest dimension. In some embodiments, the frame 12 has a thickness of 0.3 mm to 6 mm. In some embodiments, the frame 12 has a thickness of 0.3 mm to 5 mm. In some embodiments, the frame 12 has a thickness of 0.3 mm to 4 mm. In some embodiments, the frame 12 has a thickness of 0.3 mm to 3 mm. In some embodiments, the frame 12 has a thickness of 0.3 mm to 2 mm. In some embodiments, the frame 12 has a thickness of 0.3 mm to 1 mm.

In some embodiments, the frame 12 has a thickness of 1 mm to 7 mm. In some embodiments, the frame 12 has a thickness of 1 mm to 6 mm. In some embodiments, the frame 12 has a thickness of 1 mm to 5 mm. In some embodiments, the frame 12 has a thickness of 1 mm to 4 mm. In some embodiments, the frame 12 has a thickness of 1 mm to 3 mm. In some embodiments, the frame 12 has a thickness of 1 mm to 2 mm.

In some embodiments, the frame 12 has a thickness of 2 mm to 7 mm. In some embodiments, the frame 12 has a thickness of 2 mm to 6 mm. In some embodiments, the frame 12 has a thickness of 2 mm to 5 mm. In some embodiments, the frame 12 has a thickness of 2 mm to 4 mm. In some embodiments, the frame 12 has a thickness of 2 mm to 3 mm.

In some embodiments, the frame 12 has a thickness of 3 mm to 7 mm. In some embodiments, the frame 12 has a thickness of 3 mm to 6 mm. In some embodiments, the frame 12 has a thickness of 3 mm to 5 mm. In some embodiments, the frame 12 has a thickness of 3 mm to 4 mm.

In some embodiments, the frame 12 has a thickness of 4 mm to 7 mm. In some embodiments, the frame 12 has a thickness of 4 mm to 6 mm. In some embodiments, the frame 12 has a thickness of 4 mm to 5 mm. In some embodiments, the frame 12 has a thickness of 5 mm to 7 mm. In some embodiments, the frame 12 has a thickness of 5 mm to 6 mm. In some embodiments, the frame 12 has a thickness of 6 mm to 7 mm.

In some embodiments, the frame 12 has a thickness of 0.3 mm. In some embodiments, the frame 12 has a thickness of 1 mm. In some embodiments, the frame 12 has a thickness of 2 mm. In some embodiments, the frame 12 has a thickness of 3 mm. In some embodiments, the frame 12 has a thickness of 4 mm. In some embodiments, the frame 12 has a thickness of 5 mm. In some embodiments, the frame 12 has a thickness of 6 mm. In some embodiments, the frame 12 has a thickness of 7 mm.

In some embodiments, the frame 12 is composed of plastic. In some embodiments, the frame 12 is composed of a polymer. In some embodiments, the frame 12 is manufactured by a molding process. In some embodiments, the frame 12 is injection molded. In some embodiments, the frame 12 is manufactured by three-dimensional printing. In some embodiments, the frame 12 is composed of metal. In some embodiments, the frame 12 is hollow. In some embodiments, the frame 12 is partially hollow. In some embodiments, the frame 12 is substantially hollow. In some embodiments, the frame 12 includes at least one hollow region. In some embodiments, at least one electronic component is located within the at least one hollow region. In some embodiments, the at least one electronic component includes sensors, batteries, processing circuitry, antennae, or inductive charging circuitry. In some embodiments, the at least one hollow region includes a plurality of hollow regions. In some embodiments, the at least one electronic component includes a plurality of electronic components. In some embodiments, the frame 12 is composed of a 3-D printed composite. In some embodiments, the composite includes at least one electronic conductor embedded therein. In some embodiments, the at least one electronic conductor includes electrical wires or 3-D printed conductors.

In some embodiments, the frame 12 includes a pair of rims 16. In some embodiments, the frame 12 includes a bridge 18 connecting the rims 16. In some embodiments, the frame includes nose pads 20 proximate to the bridge 18. In some embodiments, the frame 12 includes endpieces 22. In some embodiments, each of the endpieces 22 is located at an upper and outer portion of the corresponding one of the rims 16. In some embodiments, the frame 12 includes a pair of temples 24. In some embodiments, each of the temples 24 extends from a corresponding one of the rims 16. In some embodiments, each of the temples 24 is connected to a corresponding one of the rims 16. In some embodiments, the temples 24 are connected to the rims 16 by corresponding hinges 26. In some embodiments, the temples 24 are movably and rotatably connected to the rims 16 by the hinges 26. In some embodiments, the temples 24 are fastened to the hinges 26 by corresponding fasteners 28. In some embodiments, each of the temples 24 is rotatably moveable from and between a first position, in which the temple 24 is in an extended position to enable a user to wear the eyewear 10, and a second position, in which the temple 24 is in a retracted position for storage or other non-use purposes.

In some embodiments, each of the hinges 26 includes at least two electronically isolated components that conduct electricity. In some embodiments, the at least two electronically isolated components include metal conductors. In some embodiments, the at least two electronically isolated components include a positive conductor and a negative conductor. In some embodiments, each of the hinges 26 is a barrel hinge. In some embodiments, each of the barrel hinges includes at least two metal rings. In some embodiments, the at least two metal rings are not in electronic contact with each other. In some embodiments, the barrel hinge includes a fastener such as a screw or pin. In some embodiments, the fastener is composed of a non-electronically conducting material.

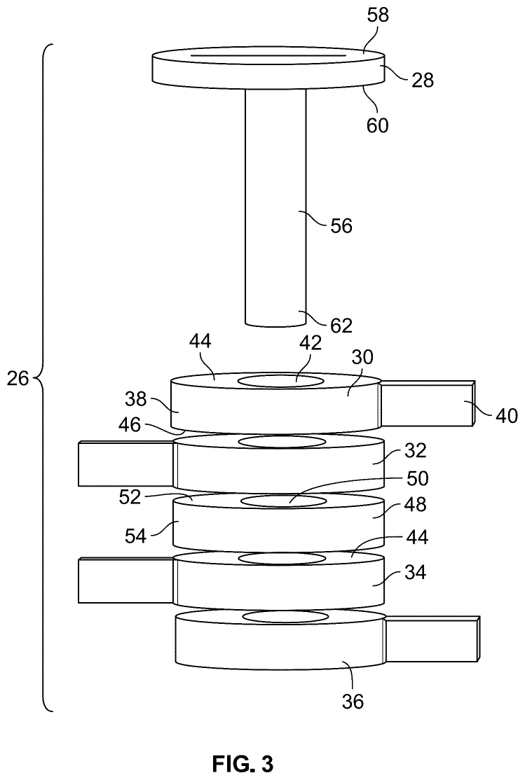

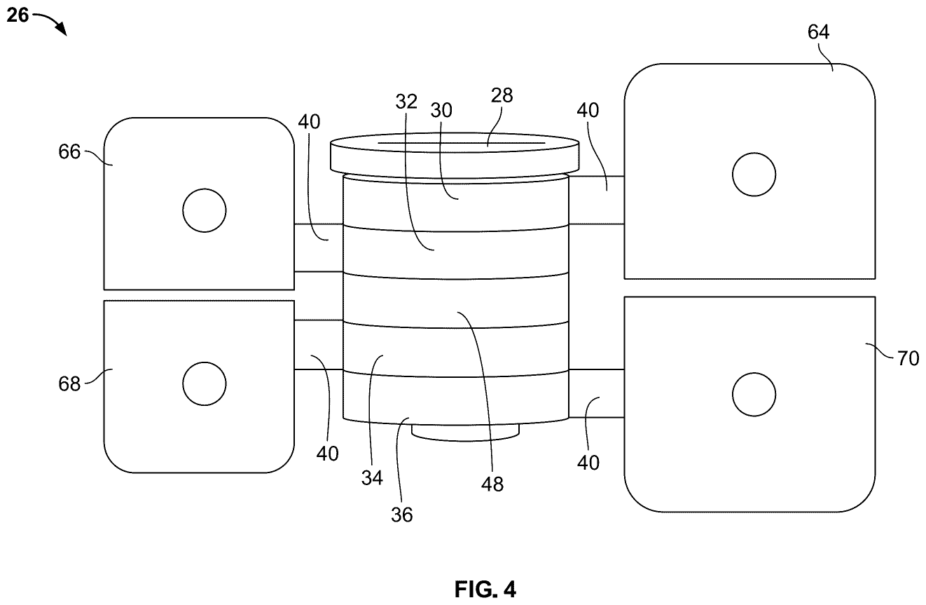

Referring to FIGS. 3 and 4, in some embodiments, each of the hinges 26 includes a first barrel 30, a second barrel 32, a third barrel 34, and a fourth barrel 36. In some embodiments, each of the first, second, third and fourth barrels 30, 32, 34, 36 includes a base 38, an arm 40 extending radially outward from the base 38, and a centrally-located aperture 42 extending from a first, upper surface 44 of the base 38 to a second, lower surface 46 of the base 38. In some embodiments, the aperture 42 is circular in shape. In some embodiments, each of the first, second, third and fourth barrels 30, 32, 34, 36 include internal threads accessed through the apertures 42. In some embodiments, the base 38 is disc-shaped. In some embodiments, the arm 40 of the first barrel 30 extends in a first direction and the arm 40 of the second barrel 32 extends in a second direction. In some embodiments, the first direction is different than the second direction. In some embodiments, the arm 40 of the third barrel 34 extends in the second direction and the arm 40 of the fourth barrel 36 extends in the first direction.

In some embodiments, the lower surface 46 of the first the first barrel 30 is juxtaposed with the upper surface 44 of the second barrel 32. In some embodiments, the lower surface 46 of the third barrel 34 is juxtaposed with the upper surface 44 of the fourth barrel 36. In some embodiments, the first barrel 30 and the second barrel 32 are rotatable relative to one another, while the third barrel 34 and the fourth barrel 36 are rotatable relative to one another. In some embodiments, the apertures 42 of the first barrel 30, the second barrel 32, the third barrel 34, and the fourth barrel 36 are aligned or substantially aligned with one another.

In some embodiments, each or any of the first barrel 30, the second barrel 32, the third barrel 34, and the fourth barrel 36 is composed of an electronically conducting material. In some embodiments, each or any of the first barrel 30, the second barrel 32, the third barrel 34, and the fourth barrel 36 is composed of a metal. In some embodiments, each or any of the first barrel 30, the second barrel 32, the third barrel 34, and the fourth barrel 36 is composed of stainless steel, aluminum, titanium, copper, magnesium, nickel, or silver.

In some embodiments, the first barrel 30 and the second barrel 32 are negative conductors. In some embodiments, the third barrel 34 and the fourth barrel 36 are positive conductors. In some embodiments, the first barrel 30 and the second barrel 32 are positive conductors. In some embodiments, the third barrel 34 and the fourth barrel 36 are negative conductors.

In some embodiments, each of the hinges 26 includes a disc 48. In some embodiments, the disc 48 includes a centrally-located aperture 50 extending from a first, upper surface 52 of the disc 48 to a second, lower surface 54 of the disc 48. In some embodiments, the disc 48 is between the second barrel 32 and the third barrel 34. In some embodiments, the disc 48 is aligned with the base 38 of the second barrel 32 and the base 38 of the fourth barrel 36. In some embodiments, the aperture 50 of the disc 48 is aligned or substantially aligned with the apertures 42 of the first barrel 30, the second barrel 32, the third barrel 34, and the fourth barrel 36. In some embodiments, the disc 48 includes internal threads accessed through the aperture 50.

In some embodiments, the disc 48 is composed of an electronically insulating material. In some embodiments, the disc 48 is composed of a polymer. In some embodiments, the disc 48 is composed of a ceramic. In some embodiments, the disc 48 separates and isolates the polarity of the first barrel 30 and the second barrel 32 from the polarity of the third barrel 34 and the fourth barrel 36.

In some embodiments, the fastener 28 fastens the first barrel 30, the second barrel 32, the disc 48, the third barrel 34 and the fourth barrel 36 to one another. In some embodiments, the fastener 28 is a pin member. In some embodiments, the fastener 28 is a screw. In some embodiments, the fastener 28 is a bolt. In some embodiments, the fastener 28 is a rod. In some embodiments, the fastener 28 includes an elongated, cylindrical shank portion 56. In some embodiments, the portion 56 includes external threads. In some embodiments, the fastener 28 includes a head 58 at one end of the shank portion 56. In some embodiments, the shank portion 56 of the fastener 28 is located within the apertures 42 of the first barrel 30, the second barrel 32, the third barrel 34 and the fourth barrel 36 and the aperture 50 of the disc 48. In some embodiments, external threads of the shank portion 56 of the fastener 28 threadedly engages the internal threads of the first barrel 30, the second barrel 32, the third barrel 34, the fourth barrel 36 and the disc 48. In some embodiments, the head 58 of the fastener 28 contacts the upper surface 44 of the first barrel 30. In some embodiments, the fastener 28 is removably fastened.

In some embodiments, the hinge 26 is assembled with two of the fasteners 28. In some embodiments, one of the fasteners 28 fastens the first barrel 30, the second barrel 32, and the disc 48 to one another, while another of the fasteners 28 fastens the third barrel 34, the fourth barrel 36, and the disc 48 to one another. In some embodiments, the disc 48 has a thickness sufficient to enable the aperture 50 to receive the shank portion 56 of one of the fasteners 28 at one end thereof and receive the shank portion 56 of another of the fasteners 28 at an opposite end thereof.

In some embodiments, the fastener 28 includes a conducting surface. In some embodiments, the conducting surface is located on the underside 60 of the head 58. In some embodiments, a bottom end 62 of the shank portion 56 opposite the head 58 includes a conducting surface. In some embodiments, the conducting surface of the underside 60 of the head 58 contacts the upper surface 44 of the first barrel 30. In some embodiments, the conducting surface located at the bottom end 62 of the shank portion 56 contacts the inner surfaces of the third barrel 34 and the fourth barrel 36 within the apertures 42. In some embodiments, the conducting surfaces facilitate the electronic connection of a portion of the circuit that is attached to the endpiece 22 the portion, which is attached to the temple 24, which will be described in further detail below. In some embodiments, the fastener 28 is plated with a metallic coating on one or more of the previously mentioned conducting surfaces. In some embodiments, the fastener 28 is composed of isolated metal sections formed within the fastener 28 and separated by an insulative region. In some embodiments, the fastener 28 always maintain electronic isolation between the pairs of the first and second barrels 30, 32 and the pairs of the third and fourth barrels 34, 36, which represent separate electronic circuits.

In some embodiments, the first barrel 30 and the second barrel 32 are independently moveable elements which are in electronic contact throughout the movement of the temple 24. In some embodiments, the third barrel 34 and the fourth barrel 36 are independently moveable elements which are in electronic contact with one another throughout the movement of the temple 24. In some embodiments, the first barrel 30 and the second barrel 32 are electronically isolated from the third barrel 34 and the fourth barrel 36 throughout the movement of the temple 24.

In some embodiments, each of the hinges 26 includes a number of barrels that is greater or less than the first, second, third, and fourth barrels 30, 32, 34, 36.

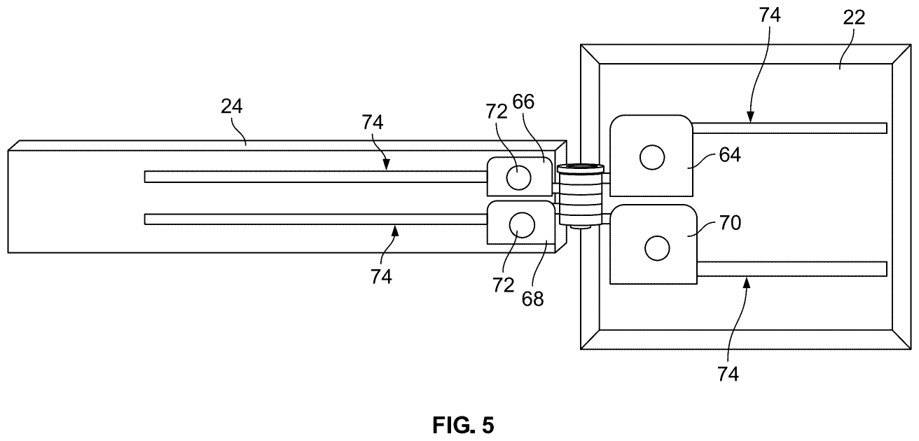

Referring to FIGS. 4 and 5, in some embodiments, each of the hinges 26 includes a first conducting pad 64. In some embodiments, the first conducting pad 64 is attached to the first barrel 30. In some embodiments, the first conducting pad 64 is attached to the first barrel 30 by the arm 40 thereof. In some embodiments, each of the hinges 26 includes a second conducting pad 66. In some embodiments, the second conducting pad 66 is attached to the second barrel 32. In some embodiments, the second conducting pad 66 is attached to the second barrel 32 by the arm 40 thereof. In some embodiments, each of the hinges 26 includes a third conducting pad 68. In some embodiments, the third conducting pad 68 is attached to the third barrel 34. In some embodiments, the third conducting pad 68 is attached to the third barrel 34 by the arm 40 thereof. In some embodiments, each of the hinges 26 includes a third conducting pad 68. In some embodiments, the third conducting pad 68 is attached to the third barrel 34. In some embodiments, the third conducting pad 68 is attached to the third barrel 34 by the arm 40 thereof. In some embodiments, each of the hinges 26 includes a fourth conducting pad 70. In some embodiments, the fourth conducting pad 70 is attached to the fourth barrel 36. In some embodiments, the fourth conducting pad 70 is attached to the fourth barrel 36 by the arm 40 thereof.

In some embodiments, each of the first, second, third and fourth conducting pads 64, 66, 68, 70 is electronically conductive with the corresponding first, second, third and fourth barrels 30, 32, 34, 36. In some embodiments, each of the first, second, third and fourth conducting pads 64, 66, 68, 70 is composed of an electronically conductive material. In some embodiments, each of the first, second, third and fourth conducting pads 64, 66, 68, 70 is composed of metal. In some embodiments, each of the first, second, third and fourth conducting pads 64, 66, 68, 70 is composed of stainless steel, aluminum, titanium, copper, magnesium, nickel, or silver. In some embodiments, each of the first, second, third and fourth conducting pads 64, 66, 68, 70 is integral with the corresponding first, second, third and fourth barrels 30, 32, 34, 36. In some embodiments, each of the first, second, third and fourth conducting pads 64, 66, 68, 70 has the same polarity as that of the corresponding first, second, third and fourth barrels 30, 32, 34, 36 (e.g., positive or negative).

In some embodiments, each of the second conducting pads 66 is attached to a corresponding one of the temples 24. In some embodiments, each of the third conducting pads 68 is attached to a corresponding one of the temples 24. In some embodiments, the second conducting pad 66 is above the third conducting pad 68. In some embodiments, the second conducting pad 66 is spaced apart from the third conducting pad 68. In some embodiments, each of the second conducting pad 66 and the third conducting pad 68 is attached to the temple 24 by a fastener 72. In some embodiments, the fastener 72 includes a rivet, screw, or rod. In some embodiments, each of the second conducting pad 66 and the third conducting pad 68 is attached to the temple 24 by an adhesive. In some embodiments, each of the second conducting pad 66 and the third conducting pad 68 is attached to the temple 24 by welding.

In some embodiments, each of the first conducting pads 64 is attached to a corresponding one of the endpieces 22. In some embodiments, each of the fourth conducting pads 70 is attached to a corresponding one of the endpieces 22. In some embodiments, the first conducting pad 64 is above the fourth conducting pad 70. In some embodiments, the first conducting pad 64 is spaced apart from the fourth conducting pad 70. In some embodiments, each of the first conducting pad 64 and the fourth conducting pad 70 is attached to the endpiece 22 by a fastener 72, an adhesive, or welding.

In some embodiments, the first, second, third and fourth conducting pads 64 are three-dimensional (3D) printed on the corresponding temples 24 and endpieces 22.

In some embodiments, one or more electrical circuit members 74 are electronically attached to one or more of the corresponding first, second, third and fourth conductive pads 64, 66, 68, 70. In some embodiments, the electrical circuit members 74 are electrical wires. In some embodiments, the electrical circuit members 74 are electrical bussing. In some embodiments, the electrical circuit members 74 are printed metallic traces. In some embodiments, the electrical circuit members 74 are embedded within the corresponding temples 24 and endpieces 22 of the frame 12. In some embodiments, each of the temples 24 has two electrical circuit members 74, each of which is electronically connected to a corresponding one of the second and third conductive pads 66, 68. In some embodiments, each of the endpieces 22 has two electrical circuit members 74, each of which is electronically connected to a corresponding one of the first and fourth conductive pads 64, 70. In some embodiments, each of the temples 24 includes more or less than the two electrical circuit members 74 (e.g., three, four, five, six, etc.). In some embodiments, a plurality of the electrical members 74 are electronically connected to the second conductive pad 66. In some embodiments, a plurality of the electrical members 74 are electronically connected to the third conductive pad 68. In some embodiments, each of the endpieces 22 includes more or less than the two electrical circuit members 74 (e.g., three, four, five, six, and so on). In some embodiments, a plurality of the electrical members 74 are electronically connected to the first conductive pad 64. In some embodiments, a plurality of the electrical members 74 are electronically connected to the fourth conductive pad 70. In some embodiments, the electrical members 74 in the temple 24 are spaced apart from one another. In some embodiments, the electrical members 74 in the temple 24 are electronically isolated from one another. In some embodiments, the electrical members 74 in the endpiece 22 are spaced apart from one another. In some embodiments, the electrical members 74 in the endpiece 22 are electronically isolated from one another.

In some embodiments, each of the electrical circuit members 74 has the same polarity as that of the corresponding first, second, third and fourth conductive pads 64, 66, 68, 70 and the corresponding first, second, third and fourth barrels 30, 32, 34, 36 (e.g., positive or negative). In some embodiments, each of the electrical circuit members 74 transmit power, electronic information and/or signaling.

In some embodiments, exterior portions of one or more components of the hinges 26, such as the first, second, third and fourth barrels 30, 32, 34, 36 and/or the first, second, third and fourth conductive pads 64, 66, 68, 70 and/or the electrical circuit members 74 are coated with an electronically insulating coating. In some embodiments, the coating is an epoxy or other type of paint, a polymer film, or an electrically insulating anodized conversion coating.

In some embodiments, the hinges 26 are configured to transmit power and/or electronic information from the temples 24 to the endpieces 22 of the rims 16 to operate the lenses 14. In some embodiments, the hinges 26 are configured to transmit power, electronic information and/or signaling from the temples 24 to the rims 16 without shorting the positive conductor and the negative conductor.

In some embodiments, each of the hinges 26 may include an amount of pairs of barrels that is greater than the first, second, third, and fourth barrels 30, 32, 34, 36, and in turn, an amount of conducting pads that is greater than the first, second, third and fourth conducting pads 64, 66, 68, 70 and associated additional electrical members 74 to provide additional conductive pathways between the temples 24 and the endpieces 22.

In some embodiments, the eyewear 10 includes at least one power source 80. In some embodiments, the at least one power source 80 is embedded within the frame 12. In some embodiments, power source 80 is encapsulated within the frame 12. In some embodiments, the at least one power source 80 is located on a surface of the frame 12.

In some embodiments, the at least one power source 80 is attached to the frame 12. In some embodiments, the at least one power source 80 is located on or within the bridge 18. In some embodiments, the at least one power source 80 is located on or within at least one of the endpiece 22. In some embodiments, the at least one power source 80 is located on or within at least one of the temples 24. In some embodiments, the at least one power source 80 is located on or within at least one of the rims 16. In some embodiments, the at least one power source 80 includes at least two power sources 80. In some embodiments, each of the at least two power sources 80 is located on or within a corresponding one of the pair of the temples 24.

In some embodiments, the at least one power source 80 is a battery. In some embodiments, the battery includes at least one cell. In some embodiments, the battery 80 is a lithium (Li) ion battery. In some embodiments, the battery includes a plurality of cells. In some embodiments, the at least one power source 80 comprises poly-para-xylylene. In some embodiments, the at least one power source 80 may comprise, include, or consist of one or more of the power sources and batteries disclosed in U.S. Pat. No. 9,177,721 to Amatucci et al, entitled “Electrochemical devices and methods of fabrication,” the disclosure of which is incorporated by reference herein in its entirety.

In some embodiments, the battery 80 is embedded within the frame 12 using additive manufacturing such as three-dimensional (3D) printing. In some embodiments, a method includes the steps of:
Printing at least one layer of a base of a component of the frame 12 (e.g., temple 24, endpiece 22) composed of a first material;
Placing the battery 80 on the base; and
Printing at least a second layer composed of the first material directly on top of the battery 80 to encapsulate it permanently with the component.

In some embodiments, the method includes the steps of forming a cavity in the at least one layer of the base; placing the battery within the cavity of the base; and printing at least a second layer over the battery to encapsulate the battery.

In some embodiments, the battery 80 embedded in the temple 24 and/or other area of the frame 12 results in a distribution of power, and the battery 80 is seamlessly integrated into the frame 12, allowing more power to be stored as various areas of the frame 12 could be utilized.

Referring to Table 1 below, in some embodiments, a wide variety of materials can used for the 3D printing process.

TABLE 1
Extruder and resin temperatures required to
deposit a variety of 3-printed filaments

| | Deposition Temperature |
|---|---|
| Material | Range (° C.) |
| ABS—Acrylonitrile Butadiene Styrene | 220-250 |
| PLA—Polylactic Acid | 190-220 |
| HIPS—High Impact Polystyrene | 230-245 |
| PETG—Glycol Modified Polyethylene | 230-250 |
| Terephthalate (PET) | |
| Nylon—Polyamide | 220-270 |
| Carbon Fiber Filled PLA, PETG, Nylon, | 220-270 |
| ABS, Polycarbonate Resins | |
| ASA—Acrylic Styrene Acrylonitrile | 235-255 |
| PC—Polycarbonate | 260-310 |
| PP—Polypropylene | 220-250 |
| Metal Filled PLA, PETG, Nylon, ABS, | 190-220 |
| and Polycarbonate | |
| Wood Filled PLA, PETG, Nylon, ABS, | 190-220 |
| and Polycarbonate | |
| PVA—Polyvinyl Alcohol | 185-200 |

In some embodiments, the battery 80 is resistant to extended temperatures greater than 85° C. In some embodiments, the battery 80 is resistant to extended temperatures from 85° C. to 250° C. In some embodiments, the battery 80 is resistant to extended temperatures from 100° C. to 200° C. In some embodiments, the battery 80 is resistant to extended temperatures from 120° C. to 130° C. In some embodiments, the battery 80 is resistant to extended temperatures in the foregoing ranges from 0.1 minute to 15 minutes. In some embodiments, the battery 80 is resistant to extended temperatures in the foregoing ranges from 1 minute to 15 minutes. In some embodiments, the battery 80 is resistant to extended temperatures in the foregoing ranges from 1 minute to 5 minutes. The term “resistant,” as used herein, means having the ability to not be adversely affected by an external element, and, in connection with the battery 80, the structure, function, operation, and/or performance of the battery 80 in its normal course is not adversely affected or substantially adversely affected by an elevated temperature for a period of time.

In some embodiments, the battery 80 includes a plurality of current collectors. In some embodiments, the current collectors are 3D printed. In some embodiments, the current collectors are composed of metal. In some embodiments, the current collectors are composed of silver. In some embodiments, the current collectors are composed of copper. In some embodiments, the current collectors are manufactured with an electrodeposition plating pen. In some embodiments, the current collectors are electrical wires. In some embodiments, the electrical wires are layer wire encased in a sheath composed of polymer, polyvinyl chloride (PVC) or polyurethane. In some embodiments, the electrical wire is composed of copper wire. In some embodiments, the current collectors are composed of nickel-plated flat ribbon wire.

### EXAMPLE 1

A battery embedded into a 3D printed structure, specifically a battery that is capable of elevated temperature exposure, more specifically, of that described and constructed in detail found in U.S. Pat. No. 9,177,721 (the “'721 Patent”). 20 mAh cells were constructed as per the teachings of the '721 Patent. The cells were divided into a group of cells that were placed on electrochemical testing immediately and another that were embedded into a 3-D printed Acrylonitrile Butadiene Styrene (ABD) monolith to evaluate the effect of embedding on power properties.

Although there exists a wide breadth of 3-D printing machines capable of depositing various polymers, for this example, a Stratasys Fortus 250MC printing ABS (a viable material for the fabrication of eyeglass frames) via fused deposition modeling (FDM) was utilized. The temperature at the tip of the filament deposition was 280° C. and the temperature at the surface of the live cell was approximately 125° C. as the molten resin was printed onto its surface. The entire chamber was held at 75° C. during the deposition to facilitate the fabrication.

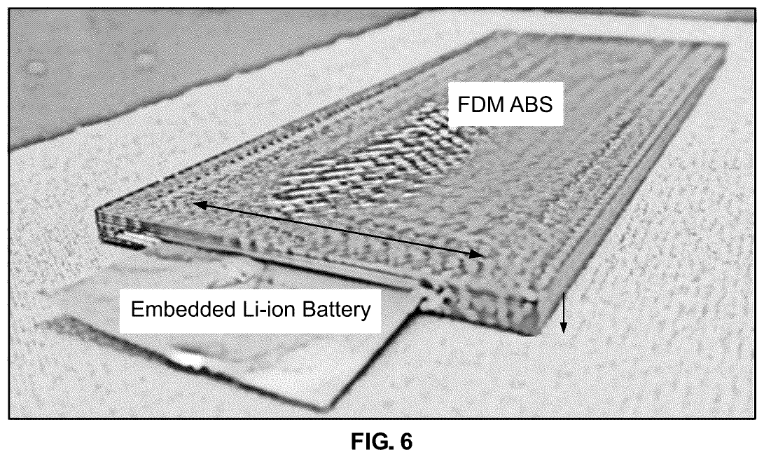

A base structure representative of an eyewear temple frame was printed. The ABS base cavity was approximately 1 mm thick, a 300 micron thick battery was placed in the cavity, and another 1 mm of ABS was printed over the live battery thereby embedding it in the ABS monolith. For practical reasons of this example, two current collectors were left extended such that the fact that a battery can be embedded at such temperatures and still function normally and thus validate the feasibility of this methodology for the frames of this invention and the embedding of such a battery itself. FIG. 6 shows the successful completion of this example in a viable format.

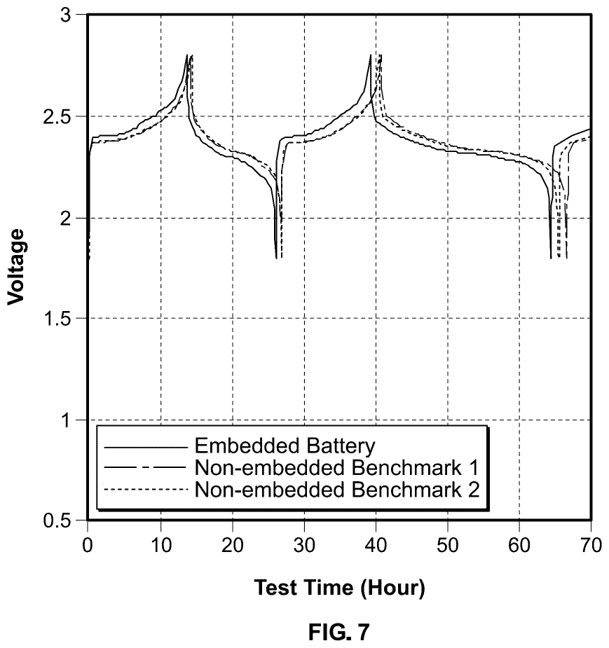

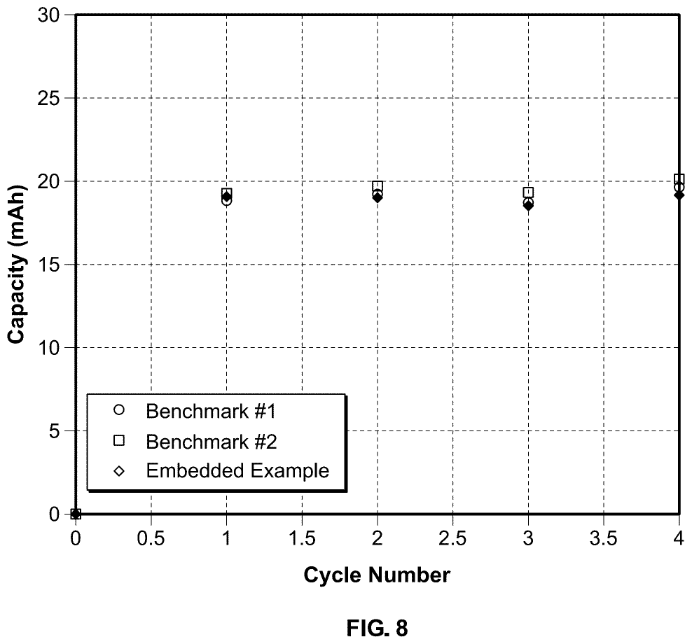

The electrochemical performance was comparable to cells which were not embedded. FIG. 7 shows a voltage vs. time profile of a cell that was not embedded versus two benchmark cells which were not. FIG. 8 shows a capacity vs. cycling plot of various cells which were embedded versus controls. The batteries were cycled at approximately C/10 charge and discharge rates. No appreciable difference was observed. The embedded cells showed similar discharge capacity and initial cycling stability as the controls which were not embedded despite being exposed to temperatures >125° C. for extended periods of time during 3-D FDM processing. The foregoing example demonstrates how it is feasible for a thin Li-ion battery to withstand the elevated temperatures involved in the 3D printing process to be successfully embedded into a temple section of the eyewear frame or any 3D printed structure, despite occurrence of high temperatures at processing.

In some embodiments, the eyewear 10 includes at least one control circuit 82. In some embodiments, the at least one control circuit 82 is embedded within the frame 12. In some embodiments, the at least one control circuit 82 is encapsulated within the frame 12. In some embodiments, the at least one control circuit 82 modulates voltage from the at least one power source 80 to the electrochromic components of the lenses 14 to change the wavelength, absorption and/or transparency thereof.

In some embodiments, the lenses 14 are composed of glass. In some embodiments, the lenses 14 are composed of plastic. In some embodiments, the lenses 14 are composed polycarbonate. In some embodiments, the lenses 14 are transparent. In some embodiments, the lenses 14 are translucent. In some embodiments, the lenses 14 are bifocal lenses. In some embodiments, the lenses 14 are gradient lenses. In some embodiments, each of the lenses 14 comprises at least one color. In some embodiments, the color is on the visible spectrum. In some embodiments, the lenses 14 are mirrored lenses. In some embodiments, the lenses 14 are electrochromic lenses. In some embodiments, the term “electrochromic lenses” as used herein are lenses that, using electrochromism, can, in whole or in part, change color upon the application of voltage and subsequent current.

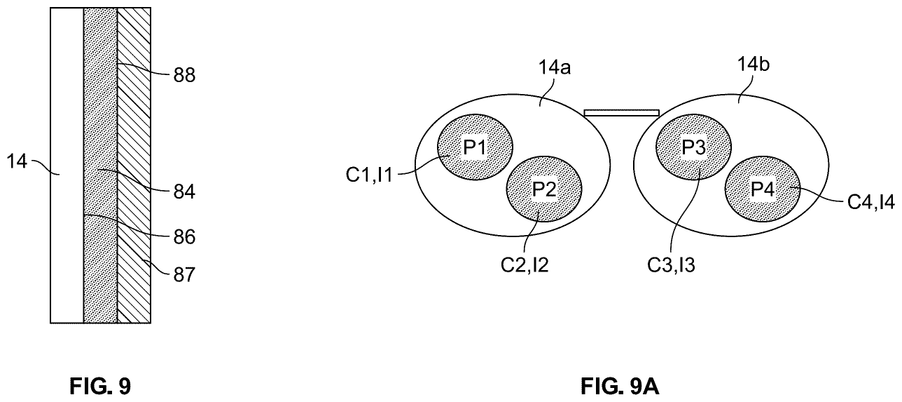

Referring to FIG. 9, in some embodiments, the lenses 14 are coated with an electrochromic thin film device 84. In some embodiments, an interior surface 86 of the lenses are coated with the electrochromic device 84. In some embodiments, the lenses 14 are prescription lenses. In some embodiments, the lenses are non-prescription lenses 14. In some embodiments, the lenses 14 include an additional coating, such as a base tint, UV A/B filters, anti-scratch, and “blue light” blocking coatings. In some embodiments, the lenses 14 include a barrier coating 87 on an exterior surface 88 of the electrochromic device 84. In some embodiments, the barrier coating 87 is transparent. In some embodiments, the barrier coating 87 enables a degree of moisture hermeticity and blocking of oxygen diffusion into the electrochromic device 84 to enable long functional life. In some embodiments, the barrier coating 87 is electronically insulating. In some embodiments, the barrier coating 87 is like coatings used on OLED devices.

In some embodiments, the electrochromic device 84 reversibly changes wavelength absorption of the lenses 14 and, in turn, a perceived color or other advantage effects with application of voltage. In some embodiments, the absorption change is enabled by a change of redox states, charge carrier densities, or the induction of structural electrochromism of the materials utilized in the electrochromic device fabrication.

In some embodiments, the lenses 14 change color and/or color intensities upon the application of a voltage. In some embodiments, the lenses change colors in various intensities dependent on the location on the lens 14. In some embodiments, a first portion of one of the lenses 14 is one color or color intensity, and a second portion different from the first portion of the same lens 14 is a second color or color intensity.

Referring to FIG. 9A, in some embodiments, a first portion P1 of a first lens 14a of the lenses 14 includes a first color C1 and a second portion P2 of the first lens 14 includes a second color C2. In some embodiments, the first color C1 of the first portion P1 of the first lens 14a includes a first color intensity I1 and the second color C2 of the second portion P2 of the first lens 14 includes a second color intensity I2.

In some embodiments, the first color C1 is the same as the second color C2 and the first color intensity I1 is the same as the second color intensity I2. In some embodiments, the first color C1 is the same as the second color C2 and the first color intensity I1 is different than the second color intensity I2. In some embodiments, the first color C1 is different than the second color C2 and the first color intensity I1 is the same as the second color intensity I2. In some embodiments, the first color C1 is different than the second color C2 and the first color intensity I1 is different than the second color intensity I2.

In some embodiments, a third portion P3 of a second lens 14b of the lenses 14 includes a third color C3 and a fourth portion P4 of the second lens 14b includes a fourth color C4. In some embodiments, the third color C3 of the third portion P3 of the second lens 14b includes a third color intensity I3 and the fourth color C4 of the fourth portion P4 of the second lens 14b includes a fourth color intensity I4.

In some embodiments, the third color C3 is the same as the fourth color C4 and the third color intensity I3 is the same as the fourth color intensity I4. In some embodiments, the third color C3 is the same as the fourth color C4 and the third color intensity I3 is different than the fourth color intensity I4. In some embodiments, the third color C3 is different than the fourth color C4 and the third color intensity I3 is the same as the fourth color intensity I4. In some embodiments, the third color C3 is different than the fourth color C4 and the fourth color intensity I4 is different than the second color intensity I2.

It would be understood that there are additional various combinations of the first color C1 and the second color C2 and the first color intensity I1 and the second color intensity I2 of the first lens 14a with the third color C3 and the fourth color C4 and the third color intensity I3 and the fourth color intensity I4 of the second lens 14b. That is, in some embodiments, one or more of the first, second, third and fourth colors C1, C2, C3, C4 are the same as or different from one another and the first, second, third and fourth color intensities I1, I2, I3, I4 are the same as or different from one another. It is also understood that, in some embodiments, the lenses 14a, 14b include more than the first, second, third and fourth portions P1, P2, P3, P4 having the same or different colors and/or color intensities.

Variable Wavelength Absorbing (Color) Electrochromic Materials and Structures

In some embodiments, electrochromism of the electrochromic device 84 of the lenses 14 is combined with photochromism to obtain optimal coloration.

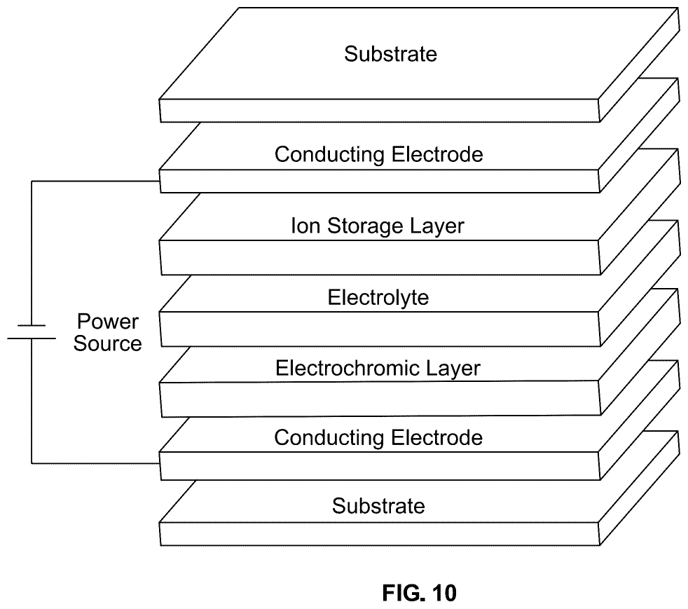

In some embodiments, materials utilized in the electrochromic device fabrication comprise inorganic materials. In some embodiments, the inorganic materials include, but not limited to, vanadium and tungsten oxides, plasmonic materials, and organic redox materials. In some embodiments, the inorganic materials provide increased lifetime and greater resistance to UV damage of the lenses 14. In some embodiments, inorganic materials include transition metal oxides (TMOs) like WO₃, MoO₃, V₂O₅, NiO, and TiO₂. In some embodiments, TMOs provide various efficiencies in specific color spectra, but when combined with structural coloration, these materials provide a full spectrum of coloration wavelengths. Referring to FIG. 10, in some embodiments, such materials are introduced into an electrochromic cell stack and the redox state, and, thus the effective coloration is changed by the concomitant insertion or removal with an electron with a mobile ion such as Li⁺, Ag⁺, or H⁺ from the electrolyte and counter electrode.

In some embodiments, materials utilized in the electrochromic device fabrication comprise organic materials (organic redox active electrochromic materials). In some embodiments, such materials provide easier processing than inorganic materials and a wide range of intense coloration. In some embodiments, examples of efficient organic electrochromic materials include Poly (3hexyl)-thiophene (P3HT), polyani-line (PANI), and polypyrrole (PPy). In some embodiments, some of these materials, such as PANI, can be utilized as both electrodes, thus widening the spectrum of coloration. In some embodiments, viologen, a bipyridine salt, provides multiple redox states which can be tuned to manipulate the output color as desired. In some embodiments, organic electrodes are incorporated into electrochromic cells in similar ways as the inorganic materials.

Plasmonic Coloration

In some embodiments, structural coloration of the lenses 14 include plasmonic nanostructures which develop wavelength absorption through the absorption properties induced by light interacting with the quanta of oscillations known as plasmon and the subsequent formation of plasmonic resonance. In some embodiments, the coloration is induced by specific plasmonic resonances developed due to the dielectric constant and resonance of materials and their surfaces. In some embodiments, tuning the coloration through spectra can be enabled by changing the size of nanoparticles or tuning the plasmonic resonances by electrochemical redox reactions of the plasmonic material itself or interaction with an electroactive electrochemical material, specifically the inorganic materials form the list above.

In some embodiments, organic redox active polymers, such as PANI, placed on silver has demonstrated a full range of coloration based on voltage for changing the local surface plasmonic resonance. In some embodiments, plasmonic coloration provides a wide tenability range can be induced, and with the use of inorganic materials, provides extreme robustness to the UV and ambient environment to which the lenses 14 are exposed. In some embodiments, metasurfaces, which are engineered ultrathin nanostructures, enable a highly effective tuning of the dielectric value leads and obtains a complete range of colors

Fabry-Perot Resonators and Cavities

In some embodiments, structural coloration of the lenses 14 utilizes the thickness and refractive index of the material which fills nanocavities to develop coloration. In some embodiments, the color is static and cavities may be filled with electrochromic or electrochemically active materials to enable switching of the cavity on or off or modulate the color spectra.

Electrochromic Bragg Diffraction Mirror

In some embodiments, structural coloration of the lenses 14 includes tuning the spatial dimensions of the electrochromic material within various ranges of light diffraction to tune light to various frequencies and provides a broad range of coloration.

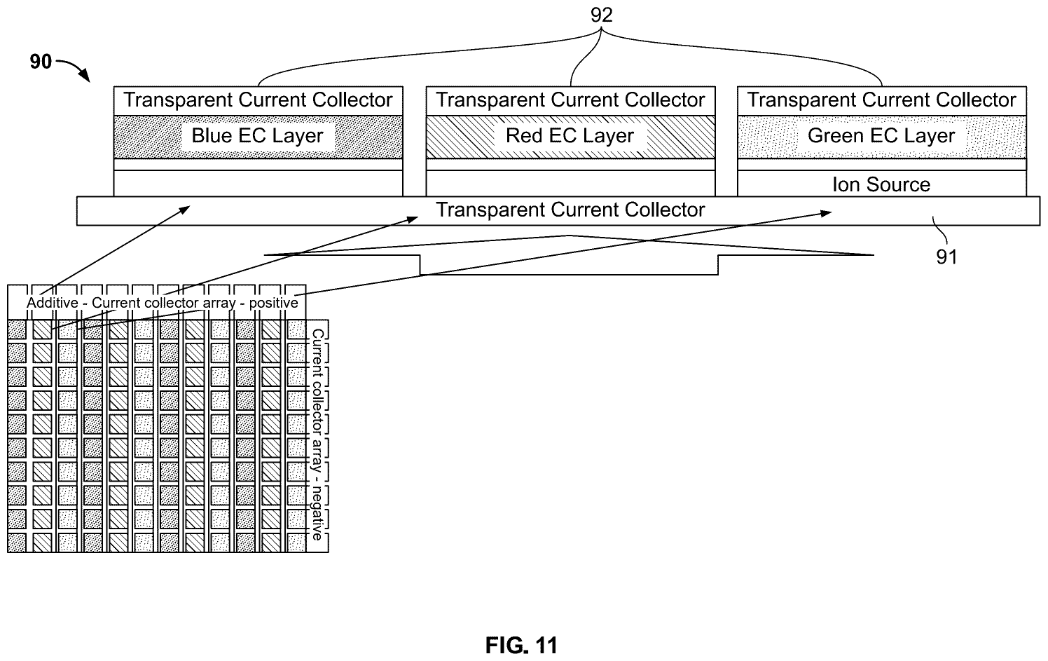

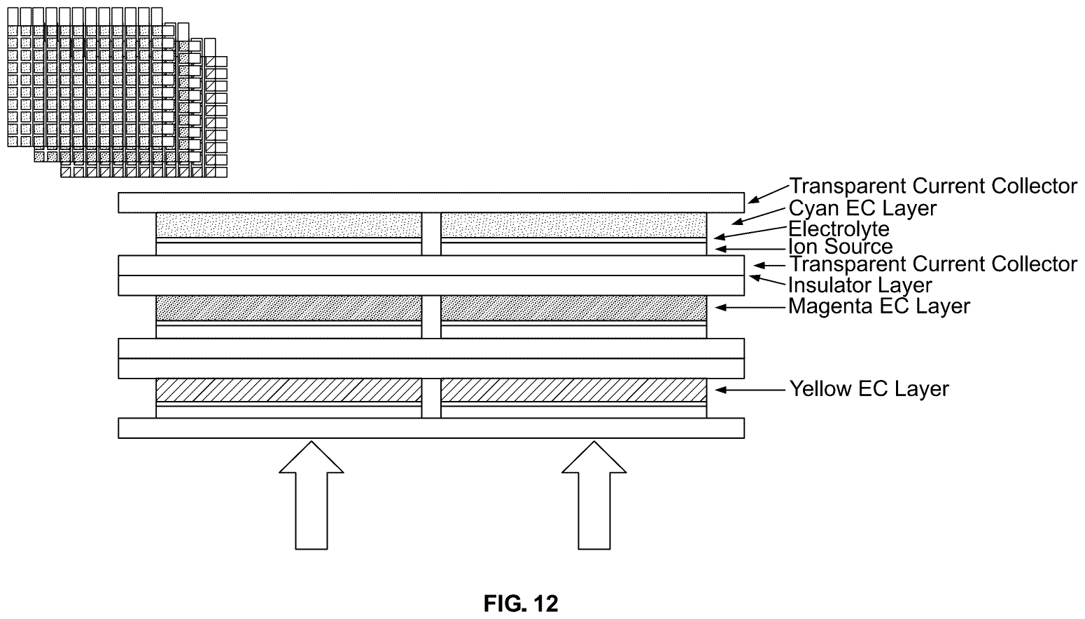

In some embodiments, the lenses change colors in various intensities dependent on the location on the lens 14. Referring to FIGS. 11 and 12, an electrochromic stack 90 includes a first transparent conducting electrode 91. In some embodiments, the conducting electrode 91 of one pole (negative or positive) is deposited in parallel arrangement on a surface of the lens 14. In some embodiments, the electrochromic stack 90 is deposited between additional conducting electrodes 92 of an opposite pole (positive or negative) on top of the stack perpendicular to the opposing pole below. In some embodiments, the width of the conducting electrodes' 91, 92 lines determine the pixel resolution (determined by the intersecting square formed by the top and bottom electrode) of the color change. In some embodiments, the line width is 10 microns to 1 cm. In some embodiments, the line width correlates to the degree of resolution required for gradient and color change across the lens 14. In some embodiments, ends of the ribbon electrodes are connected to a controller which will apply voltage across the ribbons to activate the specific pixels.

In some embodiments, to avoid crosstalk between pixels, one can isolate and pattern the active electrode or other portions of the stack from neighboring pixels. In some embodiments, the electrochromic components need only to be turned on to its desired state and the pixel has permanence, and rastering of the V can be achieved by such x-y electrode array to address each individual pixel to change its color or its intensity. In some embodiments, methodologies, and components for switching such arrays are known in the art.

In some embodiments, a color would be switched from various intensities in various portions of the lens 14 through such an array with the most efficient electrochromic stack. In some embodiments, the array would utilize a pixel stack which contains an electrochromic material which can induce coloration within a narrow or broad range dependent on the color range needed for the applications of interest. In some embodiments, the color is changed by a change in voltage of the pixel. In some embodiments, intensity of color may be by turning more pixels on or injecting more charge into the electrochromic at a specific color and redox range.

RGB: Additive Color Electrochromic

In some embodiments, the lenses 14 use a Red, Green, Blue (RGB) additive lateral array display model for the generation of interpreted color for the lenses 14. In some embodiments, the RGB model utilizes exceedingly small pixels generating various mixtures of red, green, and blue in a fine pixel space to generate a broad spectrum of colors, as the eye perceives the color in the additive mode as one depending on the pixel size (see FIG. 11). In some embodiments, the pixel size is 0.1 micron and 50 microns. In some embodiments, only three electrochromic colors are utilized. In some embodiments, to enable intensity of color at a fine pixel resolution, a simple on-off pixel color is utilized with more numerous pixels of each of RGB being available in a local space. In some embodiments, relative ratios of RGB can be changed to create different colors and control the intensity of tint. In some embodiments, viologen has been demonstrated as an electrochromic material that can generate the RGB colorations.

CMY (K): Subtractive Color Structure Electrochromic

In some embodiments, a stacked array arrangement of an array is utilized in the subtractive CMY model. Referring to FIG. 12, in some embodiments, the stacked array comprises one array of an electrochromic material idealized for Cyan, another for Magenta, another for Yellow and Black as an optional layer. In some embodiments, the human eye perceives color throughout the spectral range based on the subtractive effect of color mixing. In some embodiments,

In some embodiments, a lens 14 with a wide color spectral range is fabricated where the color change can be differentiated in any x-y coordinate of the lens surface to the finesse dictated by the pixel (rom 1 pixel to over 1,000,000 per lens) to achieve the performance, aesthetic, pain relieving, and therapeutic effects described herein.

In some embodiments, the eyewear 10 includes at least one sensor 100. In some embodiments, the at least one sensor 100 is embedded within the frame 12. In some embodiments, the at least one sensor 100 is encapsulated within the frame 12. In some embodiments, the at least one sensor 100 is located on a surface of the frame 12. In some embodiments, the at least one sensor 100 is located on or within the bridge 18. In some embodiments, the at least one sensor 100 is located on or within at least one of the endpieces 22. In some embodiments, the at least one sensor 100 is located on or within at least one of the temples 24. In some embodiments, the at least one sensor 100 is attached to the frame 12. In some embodiments, the at least one sensor 100 includes a plurality of sensors 100. In some embodiments, the at least one sensor 100 includes at least two of the sensors 100. In some embodiments, each of the at least two sensors 100 is located on or within a corresponding one of the pair of the temples 24. In some embodiments, the at least one sensor 100 may be one or more of photodiodes, photoresistors, phototransistors, and photovoltaic light sensors. In some embodiments, the at least one sensor 100 is wireless connection sensor (e.g., sensor that communicates via Bluetooth® or RF).

In some embodiments, the at least one sensor 100 is separate and located remote from the eyewear 10. In some embodiments, a system includes the eyewear 10 and the at least one sensor 100 remote from the eyewear 10. In some embodiments, the at least one sensor 100 is a wearable item. In some embodiments, the wearable item is an electronic watch. In some embodiments, the wearable item is an activity and fitness tracker. In some embodiments, the wearable item includes a skin conductance sensor. In some embodiments, the at least one sensor 100 is configured to communicate data to the eyewear 10. In some embodiments, the data includes physiological or environmental data. In some embodiments, the data is transmitted to an electronic circuit located in the eyewear 10, which, in turn, controls the absorption wavelength range of light of the lenses 14. In some embodiments, as used herein, the term “absorption wavelength range of light” is a range of wavelengths of light that an object absorbs and is capable of absorbing, and specifically herein, the lenses 14.

In some embodiments, the eyewear 10 includes a camera 120. In some embodiments, the eyewear 10 includes an antenna 122. In some embodiments, the antenna 122 enables the eyewear 10 to wirelessly connect to one or more external computer devices or sensors via wireless communication such as Bluetooth® or near field communications (NFC) to receive control input to modulate the colors of the lenses 14. In some embodiments, the computer device is a cellular phone, a smart phone, a tablet, a laptop computer, a portable computer, a desktop computer, or any other known computer devices. In some embodiments, the battery 80 is wirelessly chargeable through an inductive method. In some embodiments, the eyewear 10 includes at least one port to receive a wire connector (USB, USB 2.0, USB 3.0, etc.) for wireless charging from an external power source and/or electronic communications with an external computerized device. In some embodiments, the eyewear 10 includes at least one magnetically attachable portion to receive power from an external power source and/or electronic communications with an external computerized device.

In some embodiments, the eyewear 10 includes at least one speaker or a plurality of speakers for playback of audio. In some embodiments, one or more of the speakers are mounted to a corresponding one of the temples 24. In some embodiments, one or more of the speakers are mounted to one or more of the corresponding endpieces 22.

In some embodiments, the camera 120 is a short focal mini-camera. In some embodiments, the camera 120 is mounted on the inside of the eyewear 10. In some embodiments, the eyewear 10 includes a plurality of cameras 120. In some embodiments, one camera 120 is mounted on the inside of one temple 24 and another camera 120 is mounted on the inside of another temple 24. In some embodiments, the camera 120 is mounted on one of the endpieces 22. In some embodiments, each of the endpieces 22 includes a camera 120 mounted thereon. In some embodiments, one or each camera 120 monitors the degree of pupil dilation coupled with computer software. In some embodiments, the pupil of human eye dilates in primary response to light intensity, e.g., dilates in low light scenarios and contracts with light intensity. Excessive dilation or contraction removes the eye from its optimum pupil dilation. In some embodiments, there is an optimum degree of pupil dilation of approximately 2 mm to 3 mm in diameter, which enables the highest degree of acute vision and sensitivity. In some embodiments, the one or more cameras 120 monitor pupil dilation to automatically control the light absorption level and/or tint level of the lenses 14 in any color to maintain pupil dilation in the optimum predetermined range. In some embodiments, as opposed to monitoring the light intensity itself, the pupil monitoring of the camera 120 through pupilometery monitors the degree of stress the eye is being subjected to directly and function as an overly sensitive physiological monitor. In some embodiments, this will enable the eye to maintain optimum pupil dilation for performance. As other stimuli can also lead to pupil dilation, in some embodiments, light sensors mounted outwards on the eyewear 10 can also be used to cross correlate the data to make an informed tint adjustment.

In some embodiments, each of the lenses 14 is configured to change color in response to a user's input. In some embodiments, the input is manual input. In some embodiments, the user is the wearer of the eyewear 10. In some embodiments, the user is a medical care provider that provides the input to the eyewear 10 worn by the wearer thereof. In some embodiments, each of the lenses 14 is configured to change color automatically with the use of the at least one sensor 100 and the at least one control circuit 82. In some embodiments, the at least one sensor 100 detects physiological parameters. In some embodiments, the at least one sensor 100 detects environmental parameters. In some embodiments, the physiological parameters or function are associated with psychological states or function or the local environment of the user of the eyewear 10. In some embodiments, these physiological and environmental parameters include pulse rate, blood pressure, perspiration, stress, pupil dilation, body temperature, ambient lighting, direction, radio frequency (RF) radiation, altitude, location, acoustic signatures and/or brain activity, or combinations thereof. In some embodiments, the brain activity is measured using electroencephalography (EEG).

In some embodiments, the lenses 14 are configured to modulate their colors in parallel with one another. In some embodiments, each of the lenses 14 is configured to modulate its color independently from the other one of the lenses 14. In some embodiments, each of the lenses 14 is configured to modulate its color in multiple ranges of the visible spectrum. In some embodiments, the lenses 14 are configured to modulate their color intensities in parallel with one another. In some embodiments, each of the lenses 14 is configured to modulate its color intensity independently from the other one of the lenses 14. In some embodiments, each of the lenses 14 is configured to modulate its color intensity in multiple ranges of the visible spectrum. As used herein, the term “intensity” means the brightness or dullness of the color (also known as saturation or chroma).

In some embodiments, the process of generating a color of the lenses 14 intrinsically induces a selective reduction of other wavelengths of incident radiation reaching the user's eye. In some embodiments, selective reduction of other wavelengths such as those of higher frequency “blue” and ultraviolet may produce other beneficial effects as described herein. In some embodiments, the color of the lenses 14 is a byproduct of reducing detrimental wavelengths of the visible and non-visible spectrums, and thus, may also be tuned. In some embodiments, reducing the blue spectrum (e.g., less than 450 nm wavelength) from reaching the eye by “blue filtering” is advantageous for individuals exposed to a display screen. In some embodiments, a user of the eyewear 10 may actively change the absorption profile of the lenses 14 to filter the blue spectrum out when using the lenses 14. In some embodiments, a camera sensor or wireless connection located on the frame 12 may automatically initiate the filtering when in the presence of a display screen, such as an LCD screen. In some embodiments, intense filtering could be developed only when needed, and the degree of filtering could be adjusted based on ambient lighting conditions (sensed by an environmental sensor). In some embodiments, the color of the lenses 14 may or may not change when they are in a blue filtering mode.

Referring to FIG. 2, in some embodiments, one of lenses 14 is composed of a first color. In some embodiments, the other of the lenses 14 is composed of a second color. In some embodiments, the first color is different from the second color. In some embodiments, preselected portions of each of the lenses 14 are configured to have different colors. In some embodiments, the colors include, but are not limited to, red, orange, yellow, green, blue, indigo, and violet.

In some embodiments, the lenses 14 are configured to present information through a change in transparency by color thereof, or by presenting indicators by the way of letters, numbers and/or symbols to the wearer of the eyewear 10. In some embodiments, the information may include data generated from physiological sensors.

In some embodiments, the eyewear 10 is configured for use with psychological and physiological therapeutics. In some embodiments, the eyewear 10 is configured for use with performance enhancement of the user. In some embodiments, performance enhancement includes athletic performance. In some embodiments, the performance enhancement includes aids to enhance visual performance in various weather and environmental conditions.

In some embodiments, the present invention is configured for use in connection with helmets with visors or goggles. In some embodiments, the helmets and/or goggles may include astronaut, fighter pilot, commercial pilot, motorcycle/scooter, and sports helmets and goggles (e.g., football, hockey, lacrosse, auto racing and other sports).

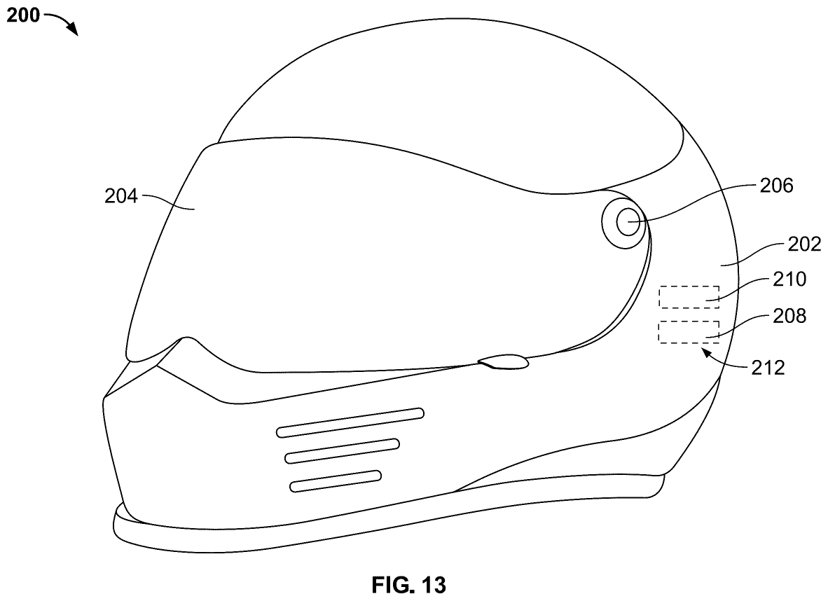

Referring to FIG. 13, in some embodiments, a helmet 200 includes a shell 202 and a visor 204 attached to the shell 202. In some embodiments, the visor 204 is moveable to, from and between a first position, in which the visor 204 overlays and covers the helmet user's eyes, and a second, retracted position, in which the visor 204 is positioned away from and uncovers the user's eyes. In some embodiments, the visor 204 includes one or more hinges 206.

In some embodiments, the visor 204 is configured to absorb at least one absorption wavelength range of light. In some embodiments, at least a portion of the visor 204 is configured to change the at least one absorption wavelength range of light absorbed in response to at least one of a physiological function, a psychological function and/or an external environment of a user of the helmet 200. In some embodiments, the at least one absorption wavelength range of light is on a visible spectrum. In some embodiments, at least a portion of the visor 204 is configured to change color. In some embodiments, the visor 204 is electrochromic.

In some embodiments, the helmet 200 includes at least one power source, such as a battery 208, and at least one electrical circuit 210. In some embodiments, the battery 208 is configured to provide power to the at least one electrical circuit 210. In some embodiments, the at least one electrical circuit 210 is configured to control the change of the at least one absorption wavelength range of light absorbed by the visor 204. In some embodiments, the shell 202 includes a wall 212 having a thickness of 1 mm to 40 mm. In some embodiments, the battery 208 is encapsulated in the wall 212. In some embodiments, the electrical circuit 210 is encapsulated in the wall 212.

In some embodiments, the visor 204 includes similar functions, features, compositions, and/or structure as of those of the lenses 14 of the eyewear 10 as described herein, and as modified in a visor form. In some embodiments, the hinge 206 includes similar functions, features, compositions, and/or structure as of those of the hinges 26 of the eyewear 10 as described herein and as modified accordingly. In some embodiments, In some embodiments, the shell 202 includes similar structure, features, compositions, and/or structure as of those of the frame 12 as modified in helmet form.

In some embodiments, the present invention is configured to be used to control and assist with pain management, dental pain, therapeutics, anxiety, induce higher performance, and to respond to rapidly changing environmental conditions (such as sunlight, glare) or for fashion preference. In some embodiments, the eyewear 10 is configured to change portions of the lenses 14 to respond to conditions that only affect a specific field of vision as determined by the at least one sensor 100. In some embodiments, for example, this can be changing a wavelength absorption in an upper right portion of a lens 14 exposed to glare or changing a lower part of the lens 14 to amber when exposed to rain/fog conditions.

In some embodiments, the present invention is configured to be used to assist users having color blindness, such that the lenses 14 include colors that improve and mimic the colors of objects not normally visualized by the users.

What is claimed is:

1. Eyewear, comprising:
a frame; and
a pair of lenses installed on the frame,
wherein each of the lenses is configured to absorb at least one absorption wavelength range of light, and
wherein at least a portion of at least one of the lenses is configured to change the at least one absorption wavelength range of light absorbed in response to at least one of a physiological function, a psychological function, an external environment of a user of the eyewear, and/or manual input by a user.

2. The eyewear of claim 1, wherein the at least one absorption wavelength range of light includes a plurality of absorption wavelength ranges of light.

3. The eyewear of claim 1, wherein the at least one absorption wavelength range of light is on a visible spectrum, and wherein the at least a portion of the at least one of the lenses is configured to change color.

4. The eyewear of claim 1, wherein each of the lenses includes an electrochromic lens.

5. The eyewear of claim 4, wherein each of the lenses is coated with an electrochromic film device, and wherein the electrochromic film device is composed of an inorganic material or an organic material.

6. The eyewear of claim 5, wherein inorganic material is a transition metal oxide or a plasmonic material.

7. The eyewear of claim 1, further comprising at least one sensor, wherein the at least one sensor is configured to detect one or more of the physiological function, the psychological function, and the external environment.

8. Eyewear, comprising:
a frame,
wherein the frame includes a pair of rims, and a pair of endpieces;
a pair of temples, each of which is movably attached to a corresponding one of the pair of the endpieces,
wherein each of the temples is attached to the corresponding one of endpieces by a corresponding one of a pair of hinges,
wherein each of the hinges includes at least one electrical conducting pathway from the corresponding one of the temples to the corresponding one of the endpieces; and
a pair of lenses installed on the frame,
wherein each of the lenses is configured to absorb at least one absorption wavelength range of light,
wherein at least a portion of at least one of the lenses is configured to change the at least one absorption wavelength range of light in response to at least one of a physiological function, psychological function, an external environment of a user of the eyewear, and/or manual input by a user, and
wherein each of the hinges are configured to transmit power and electronic information from the temples to the rims.

9. The eyewear of claim 8, wherein each of the hinges is configured to independently transmit power and electronic information from a corresponding one of the temples to a corresponding one of the rims.

10. The eyewear of claim 8, wherein each of the hinges is a barrel hinge.

11. The eyewear of claim 10, wherein each of the hinges includes a first barrel and a second barrel, wherein the first barrel and the second barrel are in electronic contact with one another, wherein each of the hinges includes a third barrel and a fourth barrel, wherein the third barrel and the fourth barrel are in electronic contact with one another, and wherein the first barrel and the second barrel are electronically isolated from the third barrel and the fourth barrel.

12. The eyewear of claim 11, wherein the first barrel of each of the hinges is attached to the corresponding one of the pair of the endpieces by a first conductor pad, wherein the second barrel of each of the hinges is attached to the corresponding one of the pair of the temples by a second conductor pad, wherein the third barrel of each of the hinges is attached to the corresponding one of the pair of the temples by a third conductor pad, and wherein the fourth barrel of each of the hinges is attached to the corresponding one of the pair of the endpieces by a fourth conductor pad.

13. The eyewear of claim 12, wherein each of the endpieces includes a first circuit member and a second circuit member, wherein each of the temples includes a third circuit member and a fourth circuit member, wherein each of the first circuit members is connected to a corresponding one of the first conductor pads, wherein each of the second circuit members is connected to a corresponding one of the second conductor pads, wherein each of the third circuit members is connected to a corresponding one of the third conductor pads, and wherein each of the fourth circuit members is connected to a corresponding one of the fourth conductor pads.

14. The eyewear of claim 13, wherein each of the hinges includes at least one fastener to fasten the first barrel and the second barrel, the third barrel and the fourth barrel to one another.

15. The eyewear of claim 14, wherein the at least one fastener electronically isolates the first barrel and the second barrel from the third barrel and the fourth barrel.

16. A hinge, comprising:
a first hinge member configured to be attached to a first component;
a second hinge member configured to be attached to a second component; and
at least one electrical conducting pathway extending between the first hinge member and the second hinge member, and
wherein the hinge is configured to transmit power and electronic information between the first component and the second component.

17. The hinge of claim 16, wherein the at least one electrical conducting pathway includes a plurality of electrically isolated conducting pathways configured to independently transmit power and electronic information.

18. The hinge of claim 16, wherein the hinge includes a barrel hinge having
a first barrel and a second barrel,
wherein the first barrel and the second barrel are in electronic contact with one another, and
a third barrel and a fourth barrel,
wherein the third barrel and the fourth barrel are in electronic contact with one another, and
wherein the first barrel and the second barrel are electronically isolated from the third barrel and the fourth barrel.

19. The hinge of claim 18, further comprising at least one fastener configured to fasten the first barrel and the second barrel, and the third barrel and the fourth barrel to one another, wherein the at least one fastener is configured to electronically isolate the first barrel and the second barrel from the third barrel and the fourth barrel.

20. The hinge of claim 16, further comprising an electronically isolating coating disposed on at least a portion of the hinge to prevent electrical shorting between the at least one electrical conducting pathway and the first hinge member and the second hinge member.
